(19) United States
(12) Patent Application Publication
(10) Pub. No.: US 2006/0036716 A1
(43) Pub. Date: Feb. 16, 2006

(54) Computer system and computer setting method

(75) Inventors: Etsutaro Akagawa, Kawasaki (JP); Akitsugu Kanda, Yamato (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/941,006

(22) Filed: Sep. 10, 2004

(30) Foreign Application Priority Data
Jul. 30, 2004 (JP) 2004-222736

(51) Int. Cl. G06F 15/177

(52) U.S. Cl. 709/220

(57) ABSTRACT

A technology is provided, with which any add-on computer becomes able to automatically acquire setting information without using a distribution server or a shared disk. A computer system is provided with: a plurality of computers for network connection; a second network connected with the computers; and an add-on computer connected to both a first network and the second network. The add-on computer is any one of the computers connected to the second network, and acquires setting information from any computer connected also to the first network for setting to itself.

### CROSS-REFERENCES TO RELATED APPLICATIONS

This application relates to and claims priority from Japanese Patent Application No. JP2004-222736, filed on Jul. 30, 2004, the entire disclosure of which is incorporated herein by reference.

### BACKGROUND

The present invention relates to a setting method for a computer in an information processing system and others.

In recent years, the demand for computer systems in terms of capability has been increasingly growing. For computer system administrators, on the other hand, required is investment reduction of computer systems. To meet such demands as capability improvement and investment reduction, a phase-in method is adopted for computer system expansion, i.e., computers to be installed in the first phase is small in number, and on an as-needed basis, the number of the computers is to be increased.

Computer addition requires to make a computer setting, which is problematically time-consuming. Especially with computer addition to anyone specific network, a lengthy routine setting operation will be repeated to make a setting in much the same manner as any existing computer(s).

To solve such problems, in Non-Patent Document 1, setting information is managed and distributed under the server client model. To be specific, in accordance with a protocol called DHCP (Dynamic Host Configuration Protocol), the setting information is distributed over a network to add-on computers thereon from a server provided for management and distribution of the setting information. Herein, Non-Patent Document 1 is “DHCP Options and Bootp Vendor Extensions”, and URL thereof is http://www.ietf.org/rfc/rfc2132.txt.

In Patent Document 1, found is a method of acquiring setting information using a shared disk accessible from a plurality of computers in a cluster-type computer system. Specifically, the shared disk is provided with the setting information in advance, and therefrom, any computers newly added to the cluster-type computer system acquire the setting information. Herein, Patent Document 1 is JP-A-2002-149413.

### SUMMARY

Non-Patent Document 1 has such a problem that distribution of the setting information from the distribution server is made also to computers those erroneously or maliciously added. As a solution therefor, computer designation is made in advance, which or what computers are allowed to be added. The server may be so structured as not to go through distribution of the setting information if any not-designated type of computer is added. With such a method, however, the scalability is poor due to the limited type of addable computers. What is more, with computer spoofing, any malicious computer can acquire the setting information with ease. Due to such problems, many networks are restricting placement of a server for setting information distribution, and thus the method of Non-Patent Document 1 is not always applicable.

In Patent Document 1, the setting information is not always available for cluster-type computer systems not using a shared disk.

In consideration thereof, an object of the present invention is to provide a technology with which any add-on computer becomes able to automatically acquire setting information without using a distribution server or a shared disk.

A computer system of the present invention is provided with a plurality of computers for network connection, a second network connected with the computers, and an add-on computer newly connected to a first network and the second network.

The add-on computer is any one of the computers connected to the second network, and the setting information is acquired from the computer connected also to the first network for setting to the add-on computer.

With such a structure, any computer to be additionally provided is allowed to automatically acquire the setting information from any other computers connected to the same network.

### BRIEF DESCRIPTION OF THE DRAWINGS

FIG. 1 is a diagram showing an exemplary structure of a computer system;

FIG. 2 is a diagram showing an exemplary setting process applied to an add-on computer;

FIGS. 3A and 3B are both a diagram showing an exemplary identification number table;

FIG. 4 is a diagram showing exemplary setting information of a computer;

FIG. 5 is a diagram showing an exemplary display screen of a management computer;

FIG. 6 is a diagram showing another exemplary setting process applied to the add-on computer; and

FIG. 7 is a diagram showing exemplary setting information to be set to the add-on computer.

### DESCRIPTION OF THE PREFERRED EMBODIMENTS

Embodiments of the present invention will be described by referring to the accompanying drawings. Note here that the present invention is not restricted to those described below.

### First Embodiment

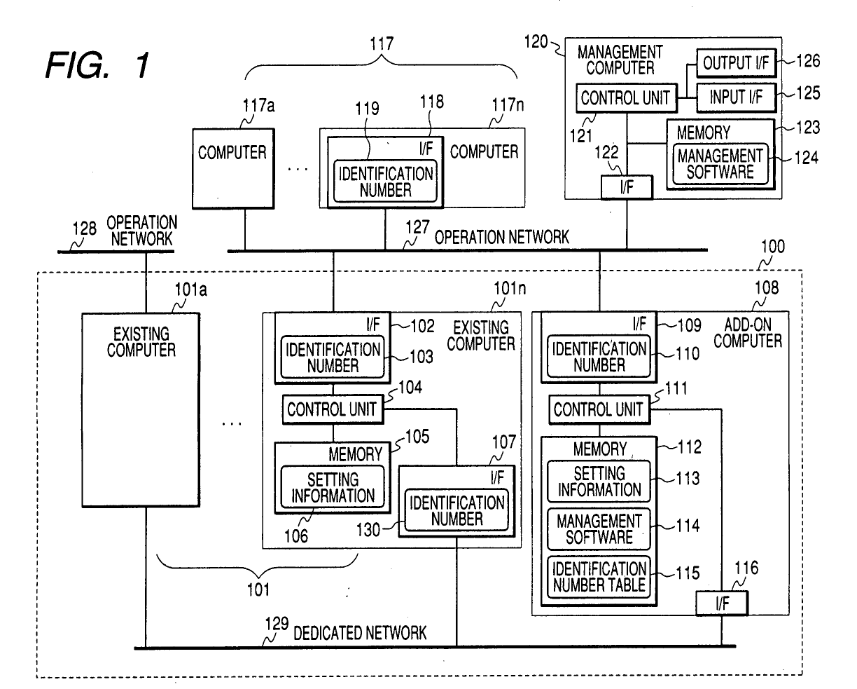

FIG. 1 is a diagram showing an exemplary structure of a computer system of a first embodiment.

In the present embodiment, existing computers found in the computer system and an add-on computer to be additionally provided thereto are presumably all of the same type.

The computer system includes one or more existing computers 101 (101a to 101n) connected to a dedicated network 129, and one or more other computers 117 (117a to 117n), and a management computer 120. Alternatively, the dedicated network 129 and the existing computer(s) 101 may structure a cluster computer system, e.g., cluster server, 100. If this is the case, the dedicated network 129 may be an intranetwork provided to the cluster computer system.

In FIG. 1, the existing computer 101a is connected to an operation network 128, and other computers, i.e., the remaining existing computers 101, the computers 117, and the management computer 120, are all connected to an operation network 127. Such a structure is aimed to show that the existing computers 101 are not necessarily all connected to any one specific network. FIG. 1 example is not the only possibility in terms of the number of the existing computers to be connected to the operation network 128 or 127. Surely, the existing computers may be all connected to the same operation network.

In the present embodiment, exemplified is a case of newly connecting an add-on computer 108 to the operation network 127 and the dedicated network 129. Herein, newly connecting the add-on computer 108 to the operation network 127 and the dedicated network 129 is equivalent to a case of newly adding the add-on computer 108 to the cluster computer system 100, for example, for connection to the operation network 127.

The existing computers 101 are each provided with: an interface (I/F) 102; memory 105; another interface 107; and a control unit 104 for exercising centralized control over the interfaces 102 and 107, and the memory 105. Herein, the interface 102 is provided for establishing a connection with the operation network 127 or 128, and the interface 107 is for connection with the dedicated network 129.

The interface 102 is assigned with a unique number for identification, i.e., identification number 103. Similarly, the interface 107 is assigned with such a unique identification number 130 for identification. The memory 105 stores setting information 106 needed for the existing computers to operate.

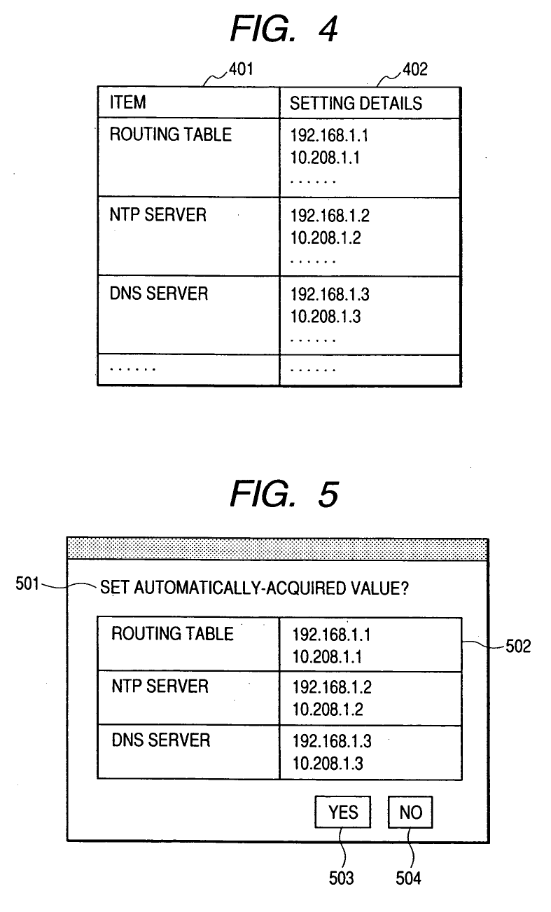

FIG. 4 is a diagram showing exemplary setting information 106 stored in the memory 105 of each of the existing computers 101. As shown in FIG. 4, the setting information 106 includes, for example, a routing table showing the distribution route for IP (Internet Protocol) packets, an IP address of an NTP (Network Time Protocol) server for time management over the computer system, and an IP address of a DNS (Domain Name Service) server for name management provided to the corresponding computer. The setting information 106 is not restricted in what it includes and in what format as long as explicitly including, as shown in FIG. 4, items 401 needed for computer operation, and items 402 each showing the setting details for the corresponding item.

Referring back to FIG. 1, the add-on computer 108 is provided with an interface 109; memory 112; another interface 116; and a control unit 111 for exercising centralized control over the interfaces 109 and 116, and the memory 112. Herein, the interface 109 is provided for establishing a connection with the operation network 127, and the interface 116 is for connection with the dedicated network 129.

The interface 109 is assigned with a unique number for identification, i.e., identification number 110. The memory 112 stores: setting information 113 needed for the add-on computer to operate; management software 114; and an identification number table 115. Specifically, the management software 114 is provided for controlling and managing the add-on computer 108 in accordance with commands coming from the management computer 120. The identification number table 115 is for storing the interface identification numbers of other computers connected to the operation network 127 or the dedicated network 129.

Note here that the setting information 113 and the identification number table 115 in the memory 112 are both information to be derived by the add-on computer 108 through processes to be executed by the management computer 120 and the management software 114. Details of the processes will be described later.

In the present embodiment, the existing computers 101 and the add-on computer 108 are of the same type, and thus the items of the setting information 113 of the add-on computer 108 is assumed to carry the same information as the items 401 of the setting information 106 of the existing computers 101.

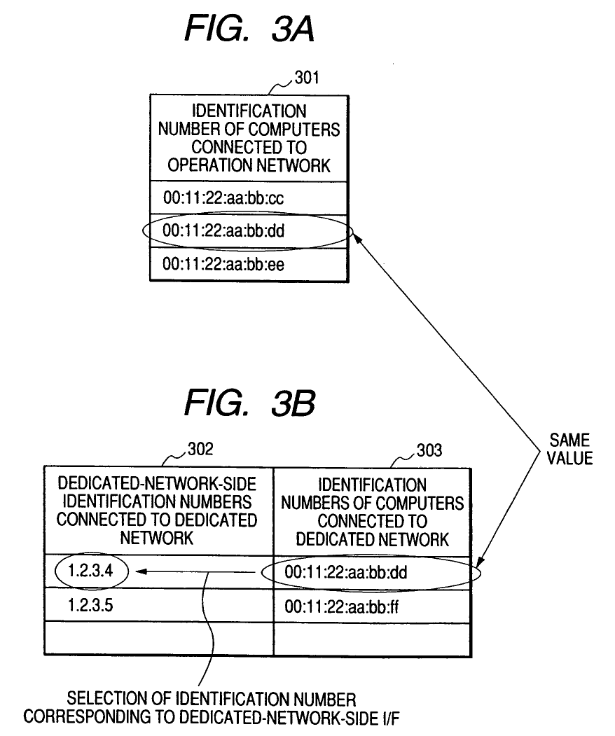

FIGS. 3A and 3B are both a diagram showing an exemplary identification number table 115 stored in the memory 112 of the add-on computer 108. The identification number table 115 includes two tables of FIGS. 3A and 3B. FIG. 3A is a table including a column 301 that carries interface identification numbers assigned to the computers connected to the operation network 127, to which the add-on computer 108 is also connected. Here, the interfaces in the column 301 are those for establishing a connection to the operation network 127. FIG. 3B includes columns 302 and 303. The column 302 carries interface identification numbers assigned to the computers connected to the dedicated network 129, to which the add-on computer 108 is also connected. Here, the interfaces in the column 302 are those for establishing a connection to the dedicated network 129. The column 303 carries interface identification numbers for establishing a connection to the operation network, which may be or may not be the same operation network as for the add-on computer 108. Note here that the identification information table 115 is not necessarily including such two tables as long as carrying information as shown in FIG. 3. The identification information table 115 is not restricted in what it includes and in what format.

Referring back to FIG. 1, the computers 117 are each provided with an interface 118 for establishing a connection to the operation network 127. This interface 118 is assigned with a unique number, i.e., identification number 119 for identification.

The management computer 120 is provided with: an interface 122; memory 123; an input interface 125; an output interface 126; and a control unit 121. Specifically, the interface 122 is provided for establishing a connection with the operation network 127. The input interface 125 is provided for receiving a computer system administrator's input, and the output interface 126 for providing the process result to the system administrator. The control unit 121 exercises centralized control over the interface 122, the memory 123, the input interface 125, and the output interface 126.

The memory 123 is storing management software 124, which analyzes a system administrator's request provided from the input interface 125, and based on the analysis result, forwards a request to the management software 114 provided to the add-on computer 108. Then, when the process result derived for the request comes from the management software 114, the result is accordingly output to the output interface 126.

Note here that the management computer 120 is means for the system administrator to use the management software 114 stored in the memory 112 of the add-on computer 108. Instead of the management computer 120, the system administrator may use the management software 114 by issuing a request thereto through the interface 109 from an input/output unit. In a still alternative manner, the management computer 120 may not be connected to the operation network 126 but to the dedicated network 129 to forward a request to the management software 114 through the interface 116.

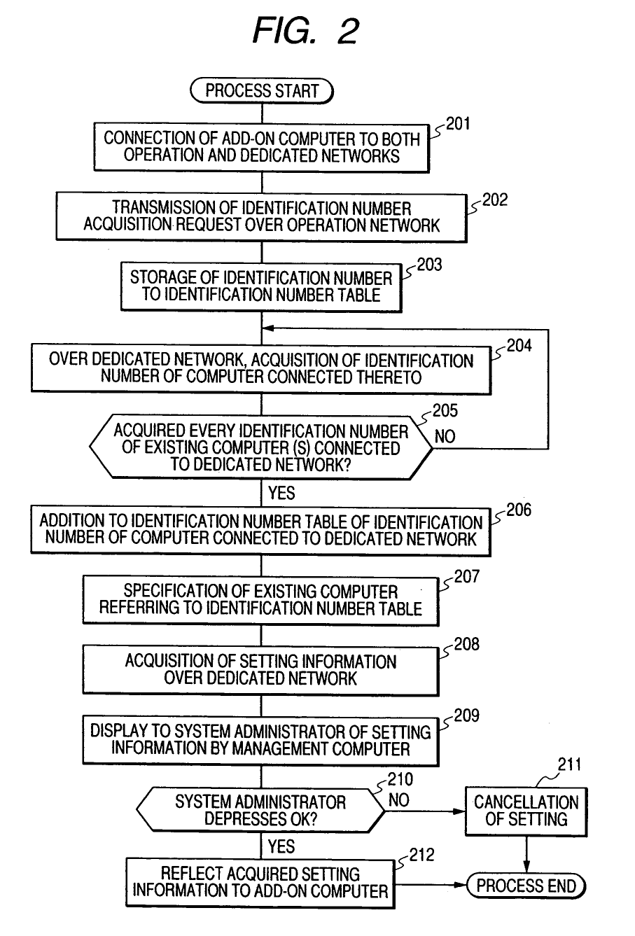

By referring to the flowchart of FIG. 2, described next is an exemplary setting process applied to the add-on computer 108 in the first embodiment.

First of all, the system administrator establishes a connection between the add-on computer 108 to the operation network 127 and the dedicated network 129 (step 201).

The control unit 111 of the add-on computer 108 then activates the management software 114. Thus activated management software 114 then forwards a request to any device connected to the operation network 127 (step S202). Here, the request is made to ask for acquiring the interface identification number 103 or 119 for connection to the operation network 127. Hereinafter, such an acquisition request is also referred to as identification number acquisition request.

The identification number acquisition request may be forwarded by using ARP (Address Resolution Protocol), for example. The ARP is a protocol for linking an IP address and a MAC (Media Control Address), which is an identification number assigned to the network interface. When additionally providing the add-on computer 108 to the computer system, the system administrator uses the management computer 120 or others to provide the interface 109 of the add-on computer 108 with an IP address and a network address. Through the use of the IP address and the network address thus provided by the system administrator, the add-on computer 108 newly added to the computer system broadcasts an IP packet over the operation network 127. As a result, the add-on computer 108 becomes able to receive an ARP packet flowing over the operation network 127. In this manner, from the received ARP packet, the add-on computer 108 can acquire the MAC address provided to the interfaces of the computer 117s or the existing computers 101. Here, the interfaces are those provided for connection to the operation network 127.

After receiving, in accordance with the identification number acquisition request, the identification number of the interface for connection to the operation network 127 from the device connected thereto, the management software 114 stores the acquired identification number to the column 301 (step 203). Specifically, the column 301 is the one provided to the identification number table 115 of FIG. 3A, indicating “identification number column 301 of computers connected to the operation network” (step 203).

Next, from the existing computers 101 connected to the dedicated network 129, the management software 114 acquires the identification number 130 or 103 (step 204). Herein, the identification number 130 is of the interface 107 for connection to the dedicated network 129, and the identification number 103 is of the interface 102 for connection to the operation network 127 or 128.

In step 204, for the management software 114 to acquire the identification numbers of the respective interfaces from the existing computers 101 connected to the dedicated network 129, the following method is an option. First, the system administrator uses the management software 114 through the management computer 120 or others to provide the interface 116 of the add-on computer 108 with any appropriate IP address and network address. With such a provision, the add-on computer 108 becomes able to communicate with the existing computers 101 over the dedicated network 129. Then, the management software 114 sequentially logs in the existing computers 101 connected to the dedicated network 129 for acquiring identification numbers. Such login is invoked using a Telnet protocol over the dedicated network 129, and acquired are the identification number 103 of the interface 102 for connection to the operation network, and the identification number 130 of the interface 107 for connection to the dedicated network 129.

In an alternative manner, to the management software 114 via the management computer 120, the system administrator may provide an address of the interface 107 on the side of the dedicated network 129 of the existing computer 101. Then, the management software may use the address to log in the existing computer 101. In a still alternative manner, the system administrator may previously set the address of the interface 107 on the side of the dedicated network 129 of the existing computer 101 to the memory 112 of the add-on computer 108, and the management software may use address information thus set in the memory 112 to log in the existing computer 101.

The management software 114 then makes a determination whether identification number acquisition is completed from all of the existing computers 101 connected to the dedicated network 129 (step 205). Here, the acquired identification numbers are those 130 and 103, belonging to the interfaces 107 and 102 on the side of the dedicated network 129 and the operation network 127 or 128, respectively.

Among the existing computers 101 connected to the dedicated network 129, if there is any not yet acquiring the identification numbers 130 and 103 of the interfaces 107 and 102 on the side of the dedicated network 129 and the operation network 127 or 128, respectively, i.e., if NO in step 205, the procedure returns to step 204 to repeat the process.

On the other hand, if all of the existing computers 101 connected to the dedicated network 129 are through with acquisition of the identification numbers 130 and 103, i.e., if YES in step 205, the management software 114 adds the identification number 103 acquired in step 204 to the column 303, and the identification number 130 to the corresponding column 302 (step 206). Here, the column 303 is the one provided to the identification number table 115 of FIG. 3B, indicating “identification number column 303 of computers connected to the operation network”. The column 302 is the one also provided to the identification number table 115 of FIG. 3B, indicating “identification number column 302 of computers connected to the dedicated network”.

The management software 114 then refers to the identification number table 115 for the column 301 of FIG. 3A, and the column 303 of FIG. 3B to check whether those two columns are carrying the same number. If these two columns carry the same number, the value corresponding thereto (found in the same line) is acquired from the column 302 of FIG. 3B (step 207). By going through such a process, the management software 114 can be connected to the same operation network 127 as the add-on computer 108, and becomes able to specify the existing computers 101 connected to the dedicated network 129.

From the existing computer 101 thus specified in step 207, the management software 114 acquires the setting information 106 in the memory 105 over the dedicated network 129 (step 208). If the existing computer 101 specified in step 207 is found plural, the management software 114 acquires the setting information 106 from the existing computer 101 of the dedicated-network-side interface 107 having the smallest identification number.

The management software 114 then forwards the setting information 106 acquired in step 208 to the management computer 120, and the management software 124 of the management computer 120 accordingly displays the system administrator the setting information 106 through the output interface 126 (step 209).

FIG. 5 is a diagram showing an exemplary screen displayed to the system administrator by the management software 124 in step 209. The management software 124 of the management computer 120 outputs a message to a display region 501 to warn the system administrator, and displays the acquired setting information to a display region 502. The management software 124 also displays both YES and NO buttons 503 and 504 to accept inputs made by the system administrator.

Referring back to FIG. 2, the management software 124 receives a system administrator's input through the input interface 125 for transmission to the management software 114 of the add-on computer 108. The management software 114 determines which button the system administrator depressed, i.e., YES button 503 or NO button 504 (step 210).

If the button depressed by the system administrator is the NO button 504, the management software 114 discards the setting information 106 acquired in step 208, and then the procedure is ended (step 211).

If the button depressed by the system administrator is the YES button 503, the management software 114 enters the setting details 402 of the setting information 106 acquired in step 208 to the setting details 402 of the setting information 113 stored in the memory 112 of the add-on computer 108 (step 212). Here, if the setting information 113 of the add-on computer 108 has no item 401, the management software 114 may enter the item 401 as the setting information 113 together with the setting details 402 in step 212.

According to the above-described embodiment, for newly adding the add-on computer 108, the add-on computer 108 may automatically acquire the setting information from the existing computers 101 connected to the same operation network. In this manner, thus acquired setting information can be reflected to the add-on computer 108 as its own. Alternatively, according to the present invention, the add-on computer 108 may automatically identify the existing computers connected to the same operation network to acquire the setting information therefrom. Still in an alternative manner, the add-on computer 108 may automatically identify the existing computers connected to the same operation network, and also to the dedicated network (intranetwork for cluster computer system) connected with only limited computers. From thus identified existing computers, the add-on computer may acquire the setting information. In this manner, the resulting setting information can be acquired from the existing computers higher in reliability than the case of acquiring the setting information merely from the existing computers connected to the same operation network.

In the present embodiment, the management software 124 on the management computer 120 is in charge of process result display in step 209, and system administrator's determination input in step 210. In an alternative manner, the management software 114 on the add-on computer 108 may take charge of such processes by including input and output interfaces, those of which are similar to those provided to the management computer 120.

### Second Embodiment

Described next is a second embodiment of the present invention.

In the first embodiment, the setting information 113 set to the add-on computer 108 presumably carry the same items as the items 401 of the setting information 106 of the existing computer 101. In the second embodiment, however, the setting information 113 of the add-on computer 108 has partially different items from the setting information 106 of the existing computer 101. If this is the case, after detecting any existing computer 101 connected to the same operation network 127 and dedicated network 129, the add-on computer 108 acquires the setting information from the existing computer 101 for comparison, in terms of items, with the setting information needed for the add-on computer 108. Then, any needed items are to be selected to make entry as its own setting information 113.

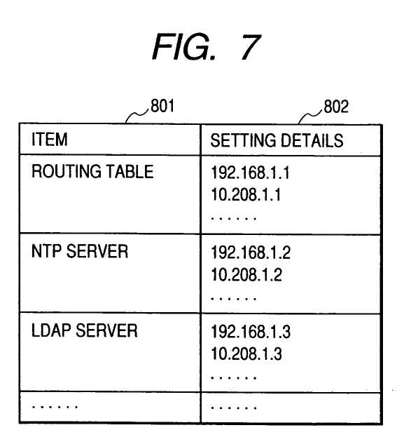

FIG. 7 is a diagram showing exemplary setting information 113 set to the add-on computer 108 in the second embodiment. An exemplary item 801 of the setting information includes a routing table, an IP address of an NTP server, and an IP address of an LDAP (Lightweight Directory Access Protocol) server for storing a user's name and a password as a pair. Here, similarly to the first embodiment, the setting information 113 set to the add-on computer 108 in the second embodiment is not restricted inwhat to carryand inwhat format as long as including the items 801 needed for the computer to operate, and items 802 each showing the setting details for the corresponding item.

Herein, the setting information 106 of the existing computer is the same as the first embodiment, and for example, may be the setting information of FIG. 4.

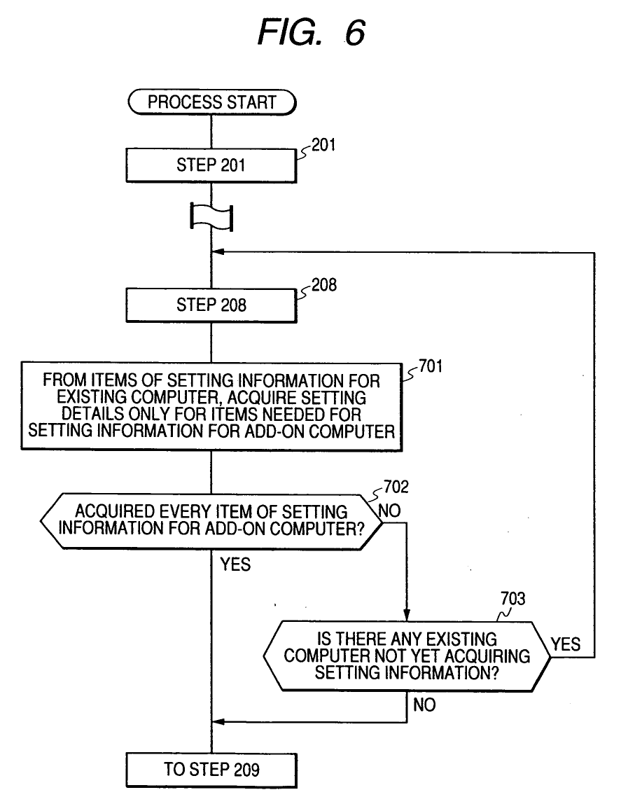

In the below, based on the flowchart of FIG. 6, described is an exemplary process for entering the setting information to the add-on computer 108 in the second embodiment.

The procedure from steps 210 to 208 is the same as the first embodiment of FIG. 2.

Out of the items 401 of the setting information 106 of the existing computer 101 acquired in step 208, the management software 114 acquires only those needed for the add-on computer 108, and the setting details 402 corresponding thereto (step 701).

Next, the management software 114 determines whether the acquisition is through for the items 801 of the setting information 113 to have setting details for the add-on computer 108 (step 702).

When the setting details 802 is through with the acquisition (YES in step 702), the procedure goes to step 209 and onward.

When the setting details 802 is not yet through with the acquisition (No in step 702), the management software 114 determines whether there is any existing computer 101 in those identified in step 207 not yet providing the setting information to the add-on computer 108 (step 703), i.e., any existing computer from which the add-on computer 108 not yet receive their setting information over the dedicated network.

If there is any existing computer 101 left as such (YES in step 703), the procedure returns to step 208 for the process continuation. This process is equivalent to a process of checking whether the setting information 106 is provided from any existing computers that are supposed to offer their setting information, and whether the setting information includes any setting item needed for the add-on computer 108. This is due to the possibility that, if the existing computer 101 connected to the operation network 127 same as the add-on computer 108, and the dedicated network 129 is provided plural, the existing computers 101 are not always carry the same setting item.

When determined NO in step 703, the procedure continuously goes to step 209 and onward. In this case, the setting information may carry not-yet-acquired item(s) for the add-on computer 108. The management software 114 executes the process of step 209 and onward to the setting item(s) so far acquired, and makes entry of the setting information 113 to the add-on computer 108. As to the net-yet-acquired item, the system administrator may later complete setting of the setting information 113 to the add-on computer 108 by entering the setting information to the add-on computer 108 through the management computer 120, or the like.

According to such a second embodiment, for newly adding the add-on computer 108, the setting information is automatically acquired from the existing computers 101 different in type from the add-on computer 108. In this manner, thus acquired setting information can be reflected to the add-on computer 108 as its own. If the existing computers and the add-on computer carry different items for the setting information, a plurality of existing computers may be checked for their setting information. In this manner, the setting information can be acquired from a lot of existing computers for more setting items.

What is claimed is:

1. A setting method for an add-on computer to be newly provided to a computer system, comprising the steps of:
acquiring, over a first network, from at least one computer already connected to the first network to which the add-on computer is to be connected, a first identification number of a first interface provided for establishing a connection to the first network;
acquiring, over a second network, from at least one computer connected to the second network to which the add-on computer is to be connected, a second identification number of a second interface for establishing a connection to the second network, and third identification numbers of other interfaces provided to the computer;
specifying, out of the acquired third identification numbers, the third identification number which has the same value as the first identification number;
acquiring setting information from the computer to which the specified third identification number belongs; and
setting the acquired setting information to the add-on computer.

2. A setting method according to claim 1, wherein
the computer and the add-on computer connected to the second network are included in a cluster computer system,
the second network is an intranetwork in the cluster computer system, and
out of the computers locating in the cluster computer system, the add-on computer acquires the setting information from the computer connected to the same first network, and sets thus acquired setting information to itself.

3. A setting method according to claim 2, wherein
in the setting information acquired by the add-on computer from the computer in the cluster computer system connected to the same first network, a routing table is included.

4. A setting method according to claim 2, wherein
in the setting information acquired by the add-on computer from the computer in the cluster computer system connected to the same first network, an IP address of an NTP server is included.

5. A setting method according to claim 2, wherein
in the setting information acquired by the add-on computer from the computer in the cluster computer system connected to the same first network, an IP address of a DNS server is included.

6. A setting method according to claim 1, wherein
the step of specifying the third identification number includes a step of plurally specifying the third identification number,
the step of acquiring the setting information includes a step of acquiring the setting information from the computer to which the third identification number belongs; and
the step of acquiring the setting information includes a step of setting the setting information to the add-on computer based on the setting information acquired from a plurality of computers.

7. A setting method according to claim 6, wherein
the step of acquiring the setting information includes the steps of:
acquiring the setting information first from the computer to which any one of the third identification numbers belongs; and
acquiring setting information not included in the setting information acquired for setting to the add-on computer from the computer to which any one of the third identification numbers belongs.

8. A setting method according to claim 1, further comprising a step of
outputting the acquired setting information, wherein.
the step of setting the setting information includes a step of setting the acquired setting information to the add-on computer based on the setting information input based on the output setting information.

9. A computer system, comprising:
a plurality of computers for network connection;
a second network connected with the computers: and
an add-on computer connected to both a first network and the second network, wherein
the add-on computer is any one of the computers connected to the second network, and acquires setting information from the computer connected also to the first network for setting to itself.

10. A computer system according to claim 9, wherein
the add-on computer acquires, from a unit connected to the first network, over the first network, a first identification number of a first interface provided for establishing a connection to the first network,
the add-on computer acquires, from the computers connected to the second network, over the second network, a second identification number of a second interface for establishing a connection to the second network, and third identification numbers of other interfaces provided to the computers,
out of the acquired third identification numbers, the third identification number having the same value as the acquired first identification number is specified, and
the setting information is acquired from the computer to which the specified third identification number belongs.

11. A computer system according to claim 10, wherein
in the setting information acquired by the add-on computer from the computer to which the third identification number belongs, a routing table is included.

12. A computer system according to claim 10, wherein
in the setting information acquired by the add-on computer from the computer to which the third identification number belongs, an IP address of an NTP server is included.

13. A computer system according to claim 10, wherein
in the setting information acquired by the add-on computer from the computer to which the third identification number belongs, an IP address of a DNS server is included.

14. A computer system according to claim 10, wherein
the add-on computer specifies the third identification numbers, and
for each of the third identification numbers, the setting information is acquired from the computer to which the third identification number belongs, and based on other setting information acquired from the computers, the setting information is set to the add-on computer.

15. A computer system according to claim 14, wherein
the add-on computer first acquires the setting information from the computer to which any one of the third identification numbers belongs, and acquires setting information not included in the setting information acquired for setting to the add-on computer from the computer to any one of the third identification numbers belongs.
